(19) United States
(12) Patent Application Publication
(10) Pub. No.: US 2011/0262168 A1
(43) Pub. Date: Oct. 27, 2011

(54) FIXING DEVICE, IMAGE FORMING APPARATUS, AND IMAGE FORMING METHOD

(75) Inventor: Hirotaka Matsumoto, Kanagawa (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/042,564

(22) Filed: Mar. 8, 2011

Related U.S. Application Data
(60) Provisional application No. 61/326,325, filed on Apr. 21, 2010.

(51) Int. Cl. G03G 15/20

(52) U.S. Cl. 399/70

(57) ABSTRACT

According to one embodiment, a fixing device includes: a heating roller including a heat generating member on the inside; a pressing roller arranged to be opposed to the heating roller across a recording medium conveying path; a first temperature sensor configured to detect the temperature of the heating roller; a second temperature sensor set in non-contact with the pressing roller; a driving motor configured to drive the heating roller, and a control section configured to receive outputs from the first and second sensors and control, if the control section determines that a creep phenomenon is present in the pressing roller, the driving motor to extend a pre-run operation.

### CROSS-REFERENCE TO RELATED APPLICATION

This application is based upon and claims the benefit of priority from the prior the U.S. Patent Application No. 61/326,325, filed on Apr. 21, 2010, and the entire contents of which are incorporated herein by reference.

### FIELD

Embodiments described herein relate generally to a fixing device, an image forming apparatus, and an image forming method.

### BACKGROUND

An electronic image forming apparatus such as a copying machine or a printer transfers a developer image from a transfer belt or a photoconductive drum onto a recording medium using a transfer device and fixing, with a fixing device, the transferred developer image on the recording medium to thereby form an image.

The fixing device includes a heating roller including a heat generating member on the inside and a pressing roller covered with an elastic member.

The pressing roller is urged to the heating roller side. Therefore, if the image forming apparatus is left unattended without being operated for a long period, the elastic member of the pressing roller is deformed by the stress of the heating roller and a creep phenomenon occurs.

The deformation of the heating roller causes deterioration in image formation quality such as a fixing failure.

To solve the problem, a technique for detecting, with an optical sensor, a dent of the heating roller is proposed.

However, it is necessary to add and set the optical sensor anew. This causes an increase in manufacturing cost.

Therefore, there is a demand for a fixing device, an image forming apparatus, and an image forming method for efficiently detecting deformation of the pressing roller when the image forming apparatus is left unattended for a long time and minimizing an increase in manufacturing cost.

### BRIEF DESCRIPTION OF THE DRAWINGS

FIG. 1 is a diagram of the configuration of an image forming apparatus;

FIG. 2 is a schematic sectional view of a fixing device;

FIG. 3 is a graph of a relation between time during which the image forming apparatus is left unattended without being operated and an amount of creep that occurs in the pressing roller;

FIG. 4 is a graph of a relation between space width between a second sensor and the surface of the pressing roller and a difference between surface temperature of the pressing roller and detected temperature of the second sensor;

FIG. 5 is a diagram for explaining pre-run operation control by a control section;

FIG. 6 is a block diagram of the configuration of the image forming apparatus; and

FIG. 7 is a flowchart of the operation of the image forming apparatus.

### DETAILED DESCRIPTION

Throughout this description, the embodiments and examples shown should be considered as exemplars, rather than limitations on the apparatus and methods of the present embodiments.

Exemplary embodiments of the present invention are explained in detail below with reference to the accompanying drawings. Examples of an image forming apparatus include a copying machine, a MFP (Multifunction Peripheral) and a printer.

In general, according to one embodiment, a fixing device includes: a heating roller including a heat generating member on the inside; a pressing roller arranged to be opposed to the heating roller across a recording medium conveying path; a temperature sensor set in non-contact with the pressing roller and configured to detect the temperature of the pressing roller; and a control section configured to control, if the control section determines on the basis of an output from the temperature sensor that a creep phenomenon is present in the pressing roller, time for a pre-run operation to be longer than time for a pre-run operation performed when the creep phenomenon is absent.

In general, according to another embodiment, an image forming apparatus includes: an electrostatic latent image bearing member configured to bear an electrostatic latent image; a developer supplying unit configured to supply a developer to the electrostatic latent image and form a developer image; a transfer roller configured to transfer the developer image onto a recording medium; a heating roller including a heat generating member on the inside; a pressing roller arranged to be opposed to the heating roller across a recording medium conveying path; a temperature sensor set in non-contact with the pressing roller and configured to detect the temperature of the pressing roller; and a control section configured to control, if the control section determines on the basis of an output from the temperature sensor that a creep phenomenon is present in the pressing roller, time for a pre-run operation to be longer than time for a pre-run operation performed when the creep phenomenon is absent.

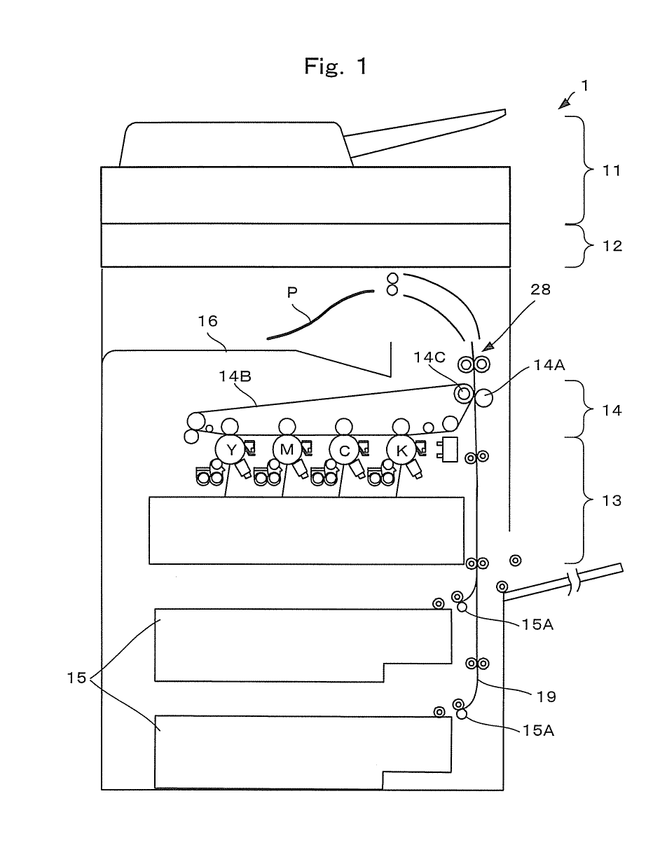

FIG. 1 is a diagram of the configuration of an image forming apparatus 1 according to an embodiment. As shown in FIG. 1, the image forming apparatus 1 includes an auto document feeder 11, an image reading section 12, an image forming section 13, a transfer section 14, a recording medium conveying mechanism 19, and a paper feeding unit 15.

The image forming apparatus 1 openably and closably includes the auto document feeder 11 in an upper part of a main body. The auto document feeder 11 includes a document conveying mechanism configured to pick up original documents from a paper feeding tray one by one and convey the original document to a paper discharge tray 16.

The auto document feeder 11 conveys, with the document conveying mechanism, the original documents to a document reading section of the image reading section 12 one by one. It is also possible to open the auto document feeder 11 and place an original document on a document table of the image reading section 12.

The image reading section 12 includes a carriage including an exposure lamp configured to expose the original document to light and a first reflection mirror, plural second reflection mirrors locked to a main body frame of the image forming apparatus 1, a lens block, and a CCD (Charge Coupled Device) of an image reading sensor.

The carriage is at a standstill in the document reading section or reciprocatingly moves under the document table to reflect the light of the exposure lamp, which is reflected by the original document, to the first reflection mirror. The plural second reflection mirrors reflect the reflected light of the first reflection mirror to the lens block. The lens block outputs the reflected light to the CCD. The CCD converts the incident light into an electric signal and outputs the electric signal to the image forming section 13 as an image signal.

The image forming section 13 includes, for each of yellow Y, magenta M, cyan C, and black K, a laser irradiating unit, a photoconductive drum serving as an electrostatic latent image bearing member, and a developer supplying unit.

The laser irradiating unit irradiates a laser beam on the photoconductive drum on the basis of the image signal and forms an electrostatic latent image on the photoconductive drum. The developer supplying unit supplies a developer to the photoconductive drum and forms a developer image from the electrostatic latent image.

The recording medium conveying mechanism 19 includes, most upstream on the paper feeding unit 15 side, a pickup mechanism 15A configured to pickup recording media one by one.

The pickup mechanism 15A picks up recording media from the paper feeding unit 15 one by one and passes the recording medium to the recording medium conveying mechanism 19. The recording medium conveying mechanism 19 conveys the recording medium to the transfer section 14.

The transfer section 14 includes a transfer belt 14B, a transfer roller 14A, and a fixing device 28. The transfer belt 14B is laid over a counter roller 14C opposed to the transfer roller 14A. The transfer belt 14B serving as an image bearing member receives transfer of the developer image on the photoconductive drum and bears the developer image. The transfer roller 14A applies a voltage to and transfers the developer image on the transfer belt 14B onto the recording medium conveyed to the transfer roller 14A. The fixing device 28 is provided downstream in a recording medium conveying direction of the transfer section 14 and heats and presses the developer image to fix the developer image on the recording medium.

In another embodiment, the image forming apparatus directly transfers the developer image from the photoconductive drum onto the recording medium. In this case, the transfer roller 14A is arranged to be opposed to the photoconductive drum.

The recording medium discharged from a paper discharge port is stacked on the paper discharge tray 16 serving as a carrying section configured to carry the recording medium.

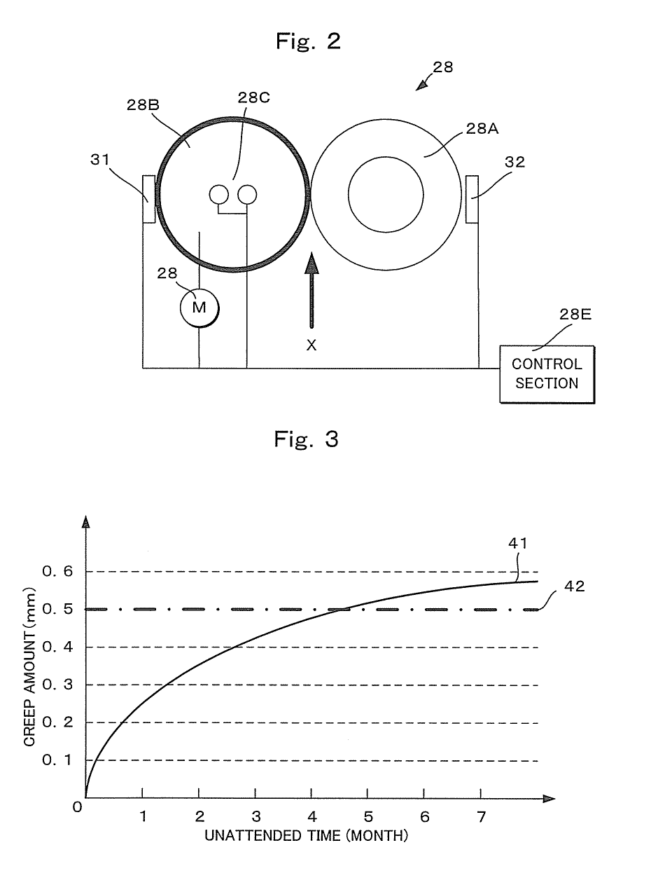

FIG. 2 is a schematic sectional view of the fixing device 28. As shown in FIG. 2, the fixing device 28 includes a heating roller 28B including a heat generating member 28C on the inside, a pressing roller 28A arranged to be opposed to the heating roller 28B across a recording medium conveying path, a first temperature sensor 31 configured to detect the temperature of the heating roller 28B, a second temperature sensor 32 set in non-contact with the pressing roller 28A, a driving motor 28D configured to drive the heating roller 28B, and a control section 28E configured to receive outputs from the first sensor 31 and the second sensor 32 and control the heat generating member 28C and the driving motor 28D.

The recording medium is conveyed in a direction of an arrow X. A thermistor can be used as the first sensor 31 and the second sensor 32. However, the first sensor 31 and the second sensor 32 are not limited to the thermistor.

The second sensor 32 can also serve as a temperature sensor set for temperature detection for the pressing device 28A of the image forming apparatus in the past. In other words, it is unnecessary to add a component anew.

The control section 28E detects the temperature of the heating roller 28B from the output of the first sensor 31 and controls the heat generating member 28C such that the temperature of the heating roller 28B is within a temperature range set in advance.

The control section 28E detects a surface temperature difference of the pressing roller 28A from the output of the second sensor 32 and controls, according to the surface temperature difference, a rotating operation performed before image formation, i.e., a pre-run operation.

FIG. 3 is a graph of a relation between time during which the image forming apparatus 1 is left unattended without being operated and the depth of a dent that occurs in the pressing roller 28A, i.e., a creep amount. The ordinate indicates the creep amount (mm) and the abscissa indicates continuous unattended time (month).

As indicated by a graph 41 shown in FIG. 3, when the unattended time passes certain time, the creep amount exceeds a threshold 42 at which a fixing failure occurs.

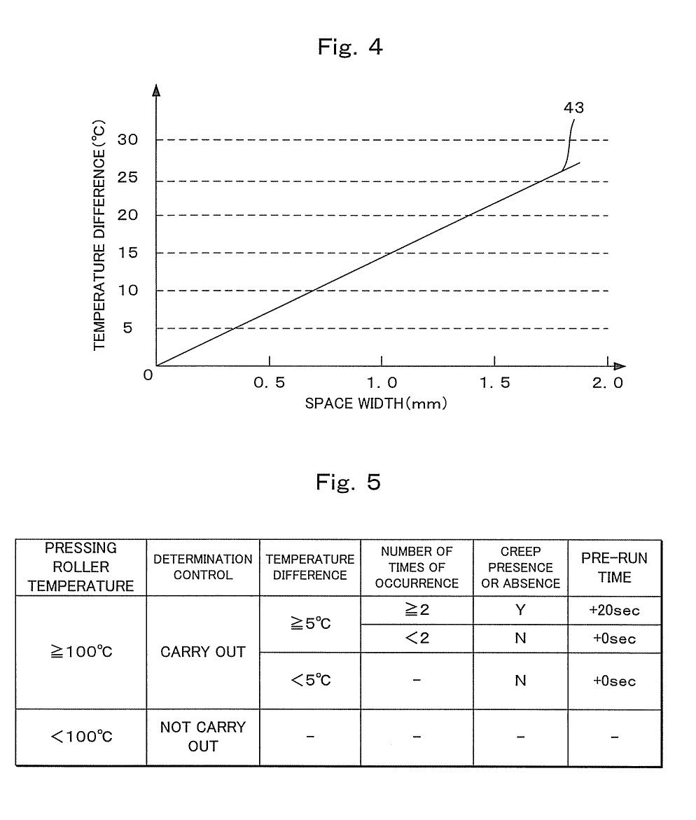

FIG. 4 is a graph of a relation between space width between the second sensor 32 and the surface of the pressing roller 28A and a difference between surface temperature of the pressing roller 28A and detected temperature of the second sensor 32. The ordinate indicates the temperature difference (° C.) and the abscissa indicates the space width (mm).

As indicated by a graph 43 shown in FIG. 4, the detected temperature difference increases as the space width increases. Therefore, if the temperature difference is detected, it is possible to detect a distance from a setting position of the second sensor 32 to the surface of the pressing roller 28A.

As shown in FIG. 3, if a fixing failure occurs when the creep amount exceeds 0.5 mm, as shown in FIG. 4, measures for a decrease in creep is necessary if the temperature difference is equal to or larger than 5° C.

FIG. 5 is a diagram of pre-run operation control by the control section 28E. As shown in FIG. 5, if the temperature of the pressing roller 28A is lower than 100° C., presence or absence of a creep phenomenon is not determined.

Control for not performing the determination of the presence or absence of the creep phenomenon is performed if a temperature detectable range of the second sensor 32 is 100° C. or higher. In other words, the determination of the presence of absence of the creep phenomenon is not performed at temperature lower than lower limit temperature of the temperature detectable range of the second sensor 32.

If the temperature of the pressing roller 28A is temperature equal to or higher than the lower limit temperature of the temperature detectable range of the second sensor 32, the control section 28E drives the driving motor 28D and detects the temperature of the heating roller 28B.

The control section 28E detects a temperature change per unit time and determines whether a difference between a maximum value and a minimum value of temperature is equal to or larger than 5° C. If the difference between the maximum value and the minimum value of temperature per unit time is equal to or larger than 5° C., the control section 28E determines how many times peaks of the maximum value are present.

If the number of times of occurrence of peaks of the maximum value is equal to or larger than two in the unit time, the control section 28E determines that the creep phenomenon is present and extends the time for the pre-run operation 20 seconds from the time for the pre-run operation performed when the creep phenomenon is absent.

Usually, the pre-run operation is performed such that the temperature of the pressing roller 28A uniformly reaches specified temperature. However, the creep phenomenon is not eliminated in the time for the pre-run operation. Therefore, the image forming apparatus 1 rotates a creep section of the pressing roller 28A to a position where the creep section does not come into contact with the heating roller 28B and eliminate the creep phenomenon.

The unit time is time longer than time during which the pressing roller 28A rotates once.

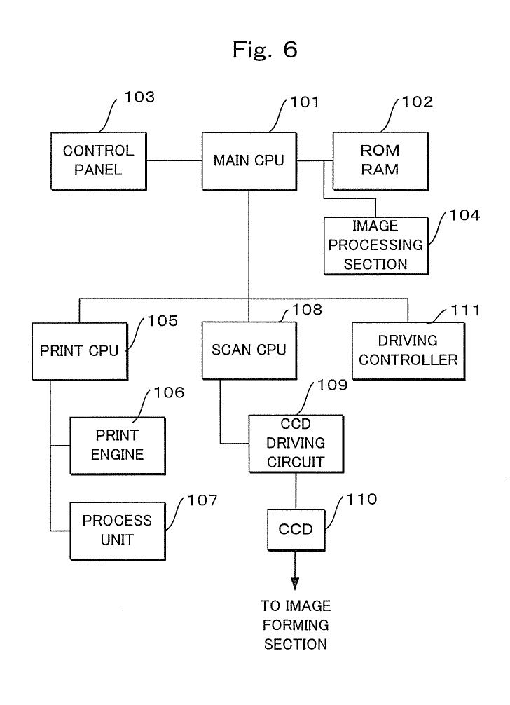

FIG. 6 is a block diagram of the configuration of the image forming apparatus 1. As shown in FIG. 6, the image forming apparatus 1 includes a main CPU 101 serving as a control section, a control panel 103 serving as a display input device, a ROM and RAM 102 serving as a storage device, and an image processing section 104 configured to perform image processing.

The main CPU 101 is connected to and controls a print CPU 105, a scan CPU 108, and a driving controller 111 included in the image forming apparatus 1.

The print CPU 105 is connected to and controls a print engine 106 configured to perform image formation and a process unit 107 including a transfer device and the fixing device 28.

The scan CPU 108 controls a CCD driving circuit 109 configured to drive a CCD 110. An output of the CCD 110 is output to the image forming section.

The driving controller 111 controls the recording medium conveying device 19.

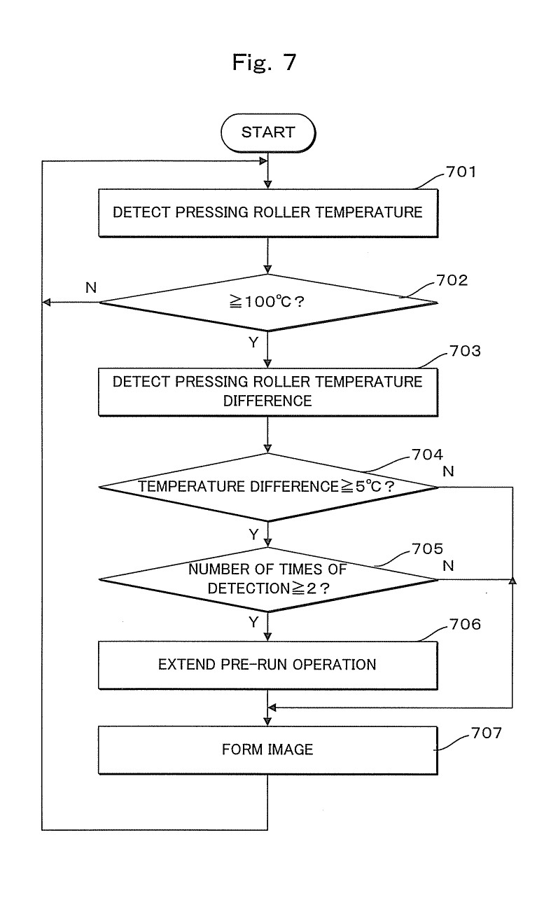

FIG. 7 is a flowchart for explaining the operation of the image forming apparatus 1. As shown in FIG. 7, in Act 701, the image forming apparatus 1 detects the temperature of the pressing roller 28A.

In Act 702, the image forming apparatus 1 determines whether the temperature of the pressing roller 28A is equal to or higher than 100° C., which is temperature lower than the lower limit temperature in the temperature detectable range of the second sensor 32. If the temperature of the pressing roller 28A is equal to or higher than 100° C., the image forming apparatus 1 proceeds to Act 703. If the temperature of the pressing roller 28A is lower than 100° C., the image forming apparatus 1 returns to Act 701.

In Act 703, the image forming apparatus 1 detects a temperature difference of the pressing roller 28A, i.e., a difference between a maximum value and a minimum value of temperature per unit time.

In Act 704, the image forming apparatus 1 determines whether the temperature difference is equal to or larger than 5° C. If the temperature difference is equal to or larger than 5° C., the image forming apparatus 1 proceeds to Act 705. If the temperature difference is smaller than 5° C., the image forming apparatus 1 proceeds to Act 707.

In Act 705, the image forming apparatus 1 counts the number of times of detection of the maximum value per unit time. If the number of times of detection of the maximum value per unit time is equal to or larger than two, the image forming apparatus 1 proceeds to Act 706. If the number of times of detection of the maximum value per unit time is smaller than two, the image forming apparatus 1 proceeds to Act 707.

In Act 706, the image forming apparatus 1 extends the pre-run operation. Extension time is time during which the creep of the pressing roller 28A decreases to be equal to or smaller than a threshold, for example, 20 seconds. In other words, the extension time for the pre-run operation is longer than time during which the pressing roller 28A rotates once.

After extending the pre-run operation in Act 706, the image forming apparatus 1 may repeat Acts 701 to 705.

In Act 707, the image forming apparatus 1 performs image formation.

As explained above, the fixing device 28 according to this embodiment includes the heating roller 28B including the heat generating member 28C on the inside, the pressing roller 28A arranged to be opposed to the heating roller 28B across the recording medium conveying path, the first temperature sensor 31 configured to detect the temperature of the heating roller 28B, the second temperature sensor 32 set in non-contact with the pressing roller 28A, the driving motor 28D configured to drive the heating roller 28B, and the control section 28E configured to receive outputs from the first sensor 31 and the second sensor 32 and control the driving motor 28D to extend the pre-run operation if the control section 28E determines that the creep phenomenon is present in the pressing roller 28A.

Therefore, there is an effect that it is possible to efficiently detect, without adding a component anew, deformation of the pressing roller if the image forming apparatus is left unattended for a long time.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. A fixing device comprising:
a heating roller including a heat generating member on an inside;
a pressing roller arranged to be opposed to the heating roller across a recording medium conveying path;
a sensor set in non-contact with the pressing roller and configured to detect temperature of the pressing roller; and
a control section configured to control, if the control section determines on the basis of an output from the temperature sensor that a creep phenomenon is present in the pressing roller, time for a pre-run operation to be longer than time for a pre-run operation performed when the creep phenomenon is absent.

2. The device according to claim 1, wherein the control section detects a difference between a maximum value and a minimum value of temperature per unit time and determines, if a number of times of detection of the maximum value is equal to or larger than two in unit time, that the creep phenomenon is present.

3. The device according to claim 2, wherein the control section determines, if a number of times the difference between the maximum value and the minimum value exceeds a threshold is equal to or larger than two, that the creep phenomenon is present.

4. The device according to claim 3, wherein the control section sets the unit time to time during which the pressing roller rotates once or more.

5. The device according to claim 4, wherein, if the control section determines that the temperature of the pressing roller is temperature equal to or higher than a lower limit temperature in a temperature detectable range of the sensor, the control section detects the difference between the maximum value and the minimum value of the temperature per unit time.

6. The device according to claim 5, wherein the control section sets extension time for the pre-run operation longer than the time during which the pressing roller rotates once.

7. The device according to claim 6, wherein the control section determines presence or absence of the creep phenomenon again after setting the extension time for the pre-run operation.

8. An image forming apparatus comprising:
an electrostatic latent image bearing member configured to bear an electrostatic latent image;
a developer supplying unit configured to supply a developer to the electrostatic latent image and form a developer image;
a transfer roller configured to transfer the developer image onto a recording medium;
a heating roller including a heat generating member on an inside;
a pressing roller arranged to be opposed to the heating roller across a recording medium conveying path;
a temperature sensor set in non-contact with the pressing roller and configured to detect temperature of the pressing roller; and
a control section configured to control, if the control section determines on the basis of an output from the temperature sensor that a creep phenomenon is present in the pressing roller, time for a pre-run operation to be longer than time for a pre-run operation performed when the creep phenomenon is absent.

9. The apparatus according to claim 8, wherein the control section detects a difference between a maximum value and a minimum value of temperature per unit time and determines, if a number of times of detection of the maximum value is equal to or larger than two in unit time, that the creep phenomenon is present.

10. The apparatus according to claim 9, wherein the control section determines, if a number of times the difference between the maximum value and the minimum value exceeds a threshold is equal to or larger than two, that the creep phenomenon is present.

11. The apparatus according to claim 10, wherein the control section sets the unit time to time during which the pressing roller rotates once or more.

12. The apparatus according to claim 11, wherein, if the control section determines that the temperature of the pressing roller is temperature equal to or higher than a lower limit temperature in a temperature detectable range of the sensor, the control section detects the difference between the maximum value and the minimum value of the temperature per unit time.

13. The apparatus according to claim 12, wherein the control section sets extension time for the pre-run operation longer than the time during which the pressing roller rotates once.

14. The apparatus according to claim 13, wherein the control section determines presence or absence of the creep phenomenon again after setting the extension time for the pre-run operation.

15. An image forming method for an image forming apparatus, comprising:
determining presence or absence of a creep phenomenon in a pressing roller arranged to be opposed to a heating roller across a recording medium conveying path on the basis of an output of a sensor set in non-contact with the pressing roller and configured to detect temperature of the pressing roller; and
extending, if it is determined that the creep phenomenon is present, time for a pre-run operation to be longer than time for the pre-run operation performed if the creep phenomenon is absent.

16. The method according to claim 15, further comprising detecting a difference between a maximum value and a minimum value of temperature per unit time and determining, if a number of times of detection of the maximum value is equal to or larger than two in unit time, that the creep phenomenon is present.

17. The method according to claim 16, further comprising determining, if a number of times the temperature difference between the maximum value and the minimum value exceeds a threshold is equal to or larger than two, that the creep phenomenon is present.

18. The method according to claim 17, further comprising setting the unit time to time during which the pressing roller rotates once or more.

19. The method according to claim 18, further comprising detecting, if it is determined that the temperature of the pressing roller is temperature equal to or higher than a lower limit temperature in a temperature detectable range of the sensor, the difference between the maximum value and the minimum value of the temperature per unit time.

20. The method according to claim 19, further comprising setting extension time for the pre-run operation longer than the time during which the pressing roller rotates once.
